(19) United States
(12) Patent Application Publication
(10) Pub. No.: US 2008/0232129 A1
(43) Pub. Date: Sep. 25, 2008

(54) Lightbar with enhanced thermal transfer

(76) Inventor: Jon H. Lyons, Haddam, CT (US)

Correspondence Address: ALIX YALE & RISTAS LLP, 750 MAIN STREET, SUITE 1400, HARTFORD, CT, 06103, US

(21) Appl. No.: 11/724,371

(22) Filed: Mar. 14, 2007

(51) Int. Cl. B60Q 1/00

(52) U.S. Cl. 362/547

(57) ABSTRACT

A lightbar assembly including a housing including a base of plastic material and warning light modules mounded in the housing. The warning light modules include LEDs attached to PC boards. Thermally conductive pads of a heat conductive plastic material are mounted in the base. A metallic heat conductive element is provided between the PC boards and the thermally conductive pads. A structural member is secured to the outside of the base and is in contact with the thermally conductive pads.

### BACKGROUND OF INVENTION

1. Technical Field

This disclosure relates generally to warning light systems for installation on land and marine vehicles, and more particularly to a lightbar having enhanced thermal transfer.

2. Background

Warning light assemblies in the form of lightbars mounted on emergency vehicles are well known in the art. The modern trend is toward compact, low profile, self-contained lightbar assemblies. Compact and low profile lightbar assemblies improve the aerodynamic efficiency and significantly reduce the wind noise relative to less compact and higher profile designs.

The lightbars are used in an environment where they are exposed to the worst of the elements, including wind, rain, ice, salt, snow and mud. As a consequence, the lightbars are a sealed unit in order to protect their internal components from exposure to the elements that would have a deleterious effect on their performance and longevity if subjected to such elements. Lightbars are also exposed to direct sunlight and temperature extremes. One concern in the design of lightbars in general, and particularly in the more compact and lower profile designs, is the problem of heat management. Due to the fact that the interior of the light bar is sealed from the outside environment, there is a possibility of the undesirable buildup of heat within the lightbar. In the cases where the light source is LEDs the heat built up can have a deleterious effect on the LEDs resulting in diminished light output and shortened component life.

Thus it is desirable that a lightbar be designed to prevent excessive heat buildup within the light bar by providing for heat transfer to the outside of the lightbar.

### SUMMARY

According to one aspect, a lightbar assembly may comprise a housing having a base and at least one warning light module mounted within the housing and including at least one LED. At least one thermally conductive pad is mounted in said base. A thermal pathway is provided from each LED to said heat transmissive pad. A support member is secured to the outside of the base of said housing and is in contact with the heat conducting pads.

According to another aspect a light bar assembly may comprise an elongated housing including a base. A plurality of light modules are mounted in said housing, the light modules including LEDs secured to a heat transmissive PC board. Thermally conductive pads are mounted in the base, each pad having an inner surface exposed to the interior of the housing and an outer surface exposed to the exterior of the housing. Heat transmissive metallic bracket members are secured to the PC boards and have a surface in engagement with the inner surfaces of the thermally conductive pads. An elongated structural member is secured to the underside of the base and is in contact with the outer surface of the thermally conductive pads.

### BRIEF DESCRIPTION OF THE DRAWINGS

This disclosure may be better understood by reference to the following description and the accompany drawings in which:

FIG. 1 is a front elevation view of a lightbar assembly incorporating the embodiments disclosed herein:

FIG. 2 is a sectional view taken through the lightbar assembly of FIG. 1;

FIG. 3 is an isometric view of one section of the base of the housing of the lightbar assembly of FIG. 1;

FIG. 4 is an isometric view of the underside of the base of FIG. 3;

FIG. 5 is an isometric view of the support member that is adapted to be received in a recess in the underside of the base of the lightbar;

FIG. 6 is an enlarged isometric view of a heat transmissive pad used in the lightbar assembly of FIG. 1;

FIG. 7 is a partial exploded isometric view showing the various components of an exemplary lightbar according to the present disclosure;

FIG. 8 is an enlarged partial sectional view of the left hand side of FIG. 2 showing the connection of the base of the light bar, heat transmissive pad, support member and the heat transmissive bracket;

FIG. 9 is an enlarged sectional view showing the connection of the base of the housing, support member and the heat transmissive bracket; and

FIG. 10 is an enlarged partial exploded isometric view similar to FIG. 7 showing the various components of an exemplary lightbar according to the present disclosure.

### DETAILED DESCRIPTION

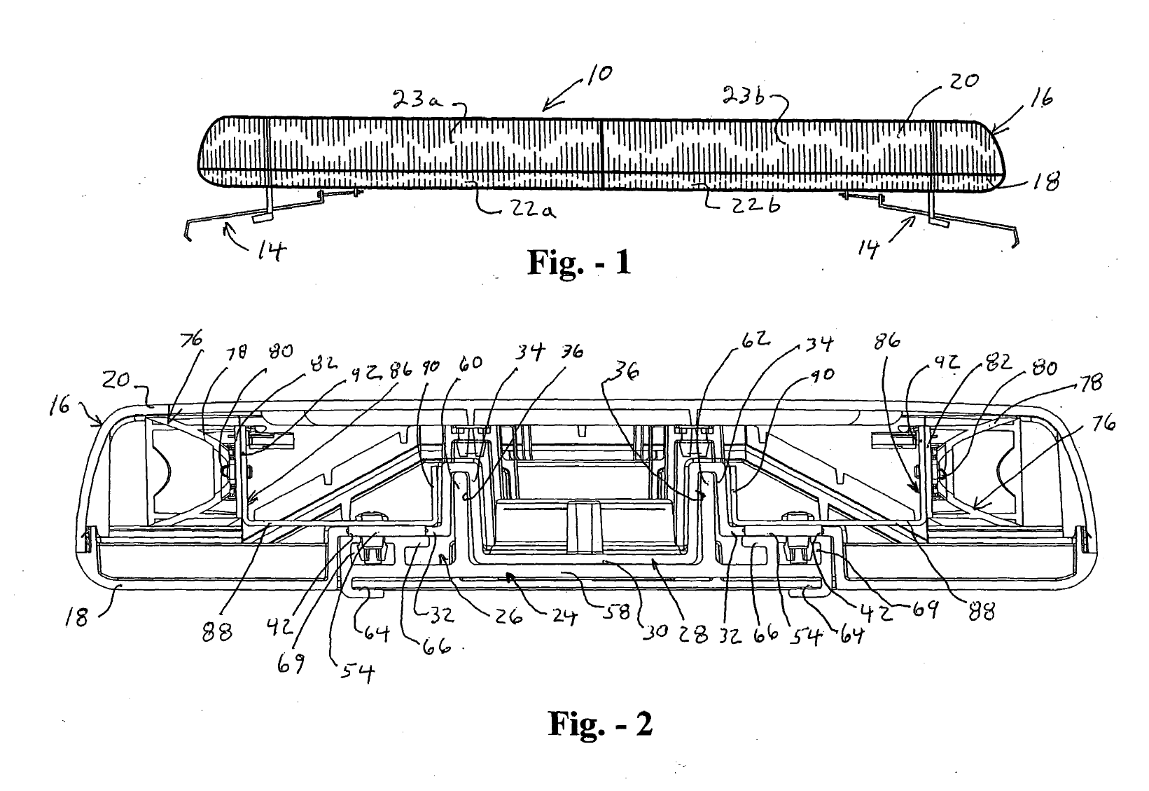

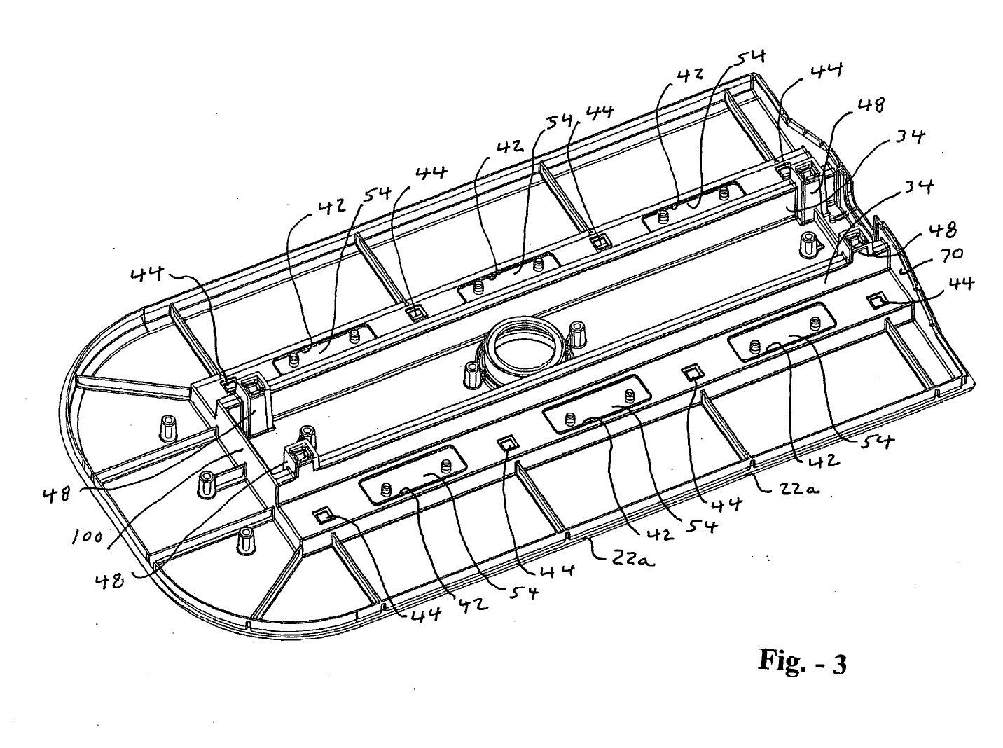

Referring to the drawings and particularly FIGS. 1 and 2, a lightbar assembly 10 includes a lightbar 12 having a mounting foot assembly 14 attached thereto at each lateral end. The mounting foot assembly 14 provides a mechanism for attaching the light bar 12 to the vehicle in a manner well known in the art. See for example U.S. Pat. No. 6,845,893 the disclosure of which is incorporated herein by reference in its entirety. The lightbar 12 includes a housing 16 comprising a base 18 and a dome 20 both of plastic material. The base 18 is shown as comprising two identical end sections 22a and 22b connected in end to end relationship. Each end section 22a and 22b is a one-piece injection molded part. By using two separable end sections 22a and 22b, it is possible to place additional base sections (not shown) between the two end sections 22a and 22b to increase the length of the lightbar 12 according to the user's needs. Similarly, the dome 20 is also comprised of two end sections 23a and 23b with the availability of adding intermediate dome sections when it is desired to lengthen the lightbar 12. The base 18 may be opaque while the dome 20 may be clear or colored depending upon the type of light effect desired. Additionally, the dome 20 may have optical spreader bands (not shown) over all or a portion of its surface depending upon the particular light module being used.

Referring to FIG. 2, a structural member in the form of an elongated support member 24 is positioned in a recess 26 in the underside of the base 18 and extends along the longitudinal axis of the lightbar 12 terminating at a point short of the ends thereof. The elongated support member 24 is preferably an aluminum extrusion, although other suitable materials and methods of manufacture may be used. The recess 26 in the base 18 extends upwardly into the housing 18 and is defined by the shape of the bottom wall 28 of the base 18. The recess is configured to receive the support member 24 and includes a longitudinally extending central segment 30 of a given depth and two longitudinally extending outer segments 32, one on either side of the central segment 30. The outer segments 32 have a depth greater than the central segment 30. The recess 26 extends longitudinally along the underside of the base 18 and terminates at a point short of each end of the base 18.

As shown in FIGS. 2-4, each section 22a and 22b of the base 18 includes a pair of spaced longitudinally extending ribs 34 which project upward into the interior of the lightbar 12 and define a channel 36 therein opening from the underside side of the base 18 into each rib 34. One rib 34 is positioned along each side of the central segment 30 of the recess 26.

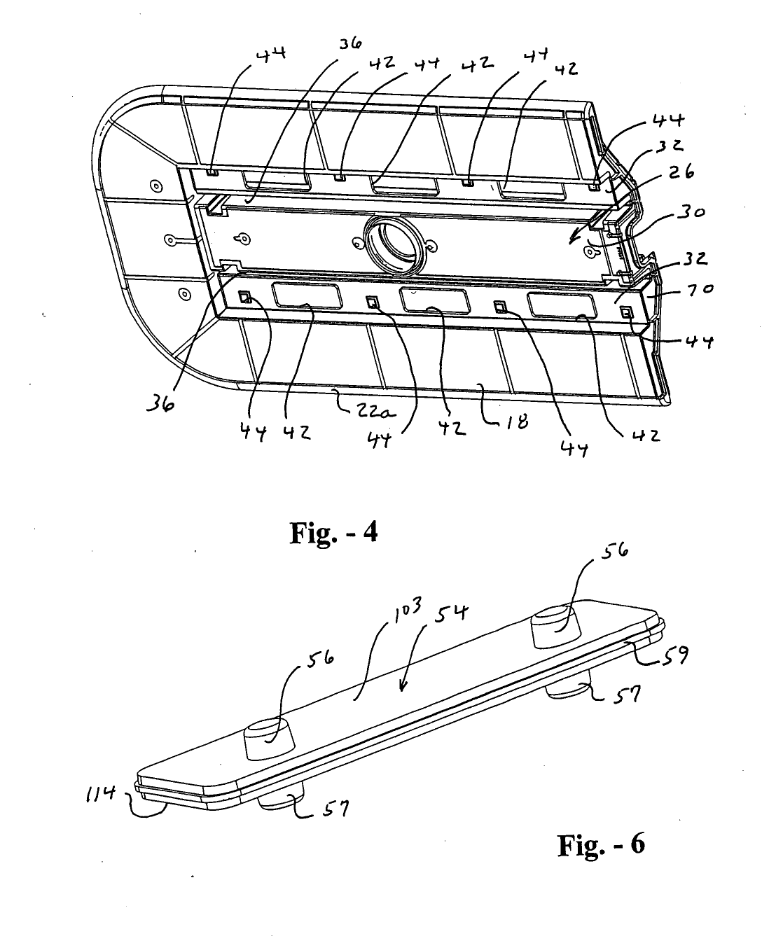

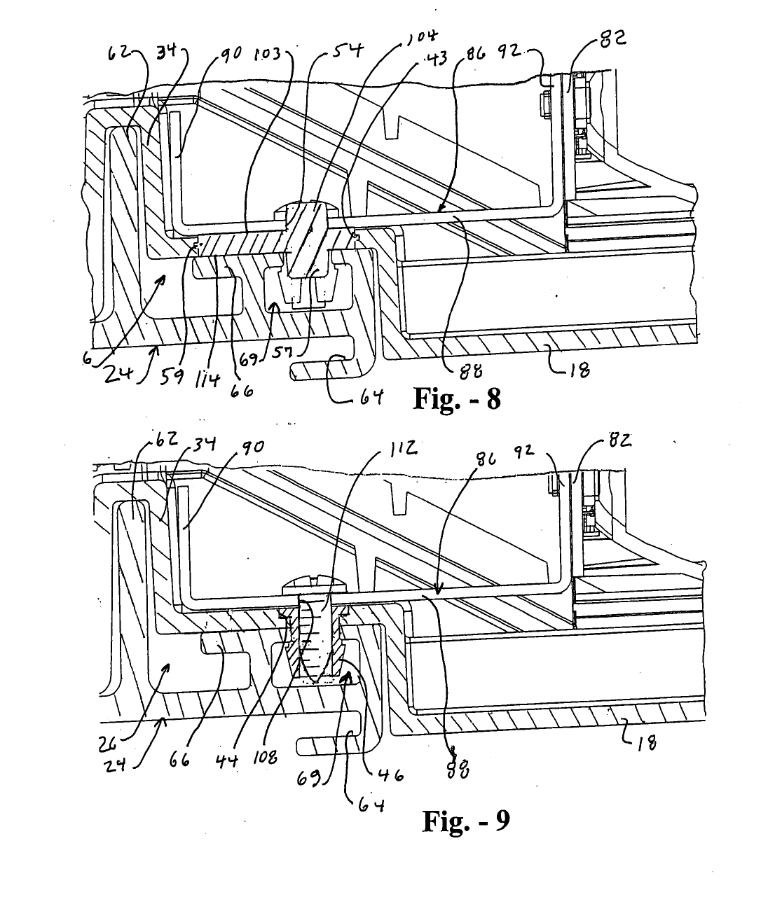

The bottom wall 28 of the base 18 defining the outer segments 32 of the recess 26 is provided with a series of generally rectangular openings 42 having an axis of elongation extending parallel to the longitudinal axis of the lightbar. Each opening 42 has a groove 43 (see FIG. 8) extending around the periphery of the opening 42. As shown in FIGS. 3 and 4, there are six such openings 42 in each of the bottom sections 22a and 22b, three on each side of the central segment 30 of the recess 26.

Square shaped holes 44 are provided in the bottom wall 28 of the base 18 in the each outer segment 32 of the recess 26. There are four holes 44 in each outer segment 32, with a hole 44 positioned between adjacent ends of the rectangular openings 42 and one hole 44 slightly spaced from each of the end openings 42 as shown in FIGS. 3 and 7. The holes 44 are countersunk to receive the head of a fastener element such as a square-headed expandable screw grommet 46. Four hollow square-shaped posts 48 extend upwardly from the bottom wall 28 of each segment 22a and 22b of the base 18 to a point higher than the ribs 34 and are also countersunk to receive square-headed screw grommets 46 (FIG. 7). There are four posts 48 in each of the bottom sections 22a and 22b, one near the end of each rib 34 as shown in FIGS. 3 and 7.

A thermally conductive pad 54 of a heat conductive plastic material is positioned in each of the openings 42. The heat conductive material may be a CoolPoly® thermally conductive plastic, a thermally conductive injection molding grade thermoplastic material produced by Cool Polymers, although any other highly heat conductive plastic material may be used. The thermally conductive pad 54 is preferably molded in place and is of a thickness slightly greater than the thickness of the bottom wall 28 of the base 18. Each thermally conductive pad 54 includes two longitudinally spaced, upwardly extending cylindrical projections 56 and two downwardly extending projections 57. Each thermally conductive pad 54 also has a tongue 59 extending around its perimeter which is received in the groove 43 in the periphery of the opening 42 to secure the thermally conductive pad 54 within the opening 42.

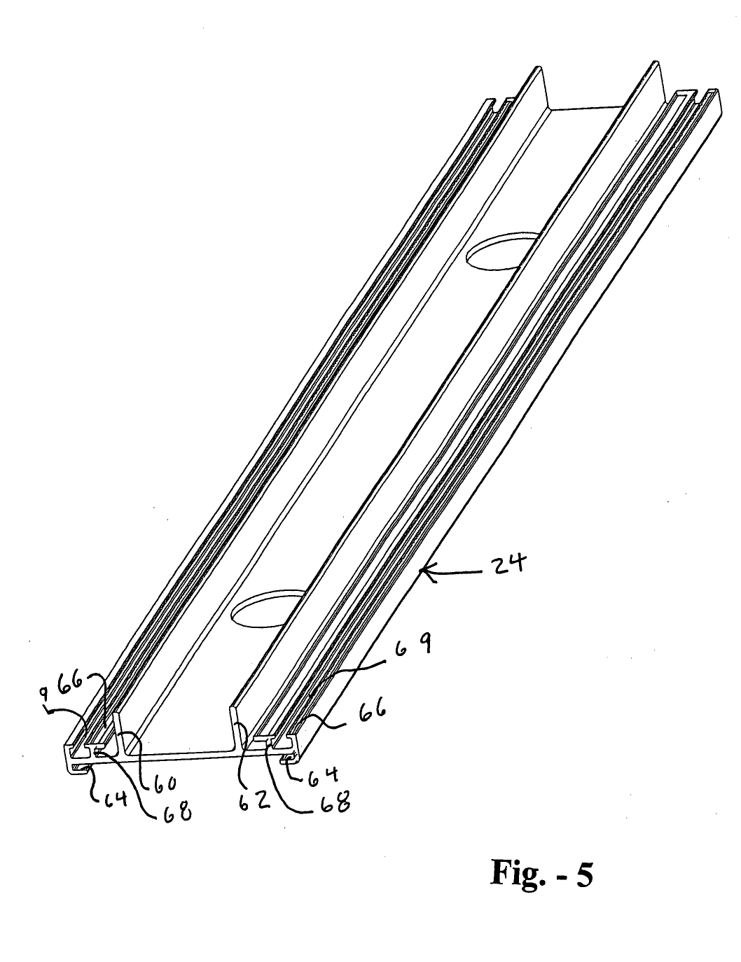

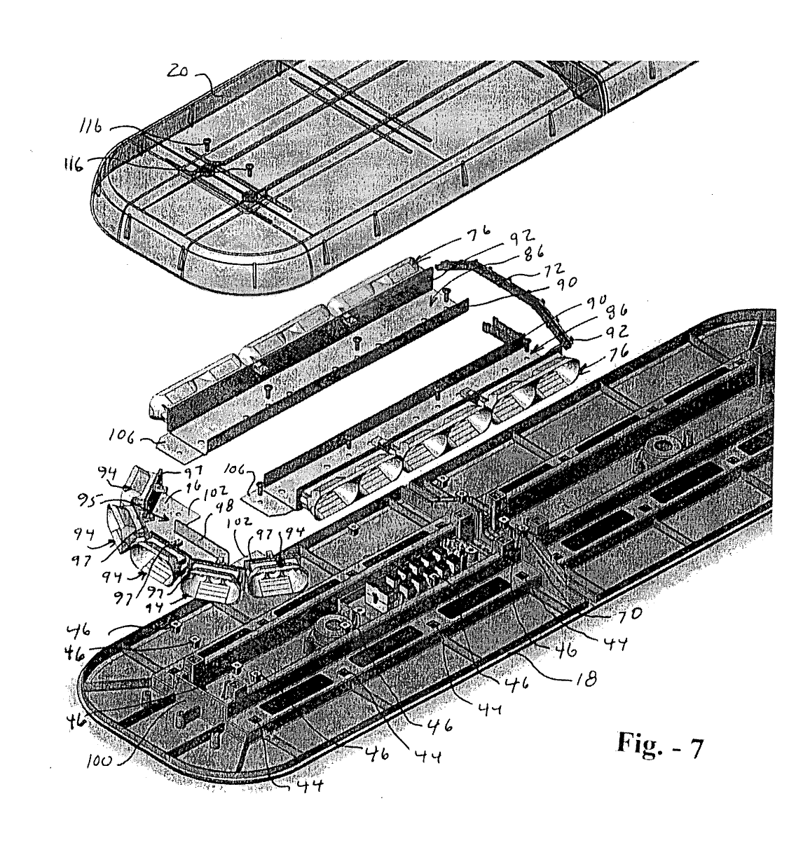

As shown particularly in FIGS. 2 and 5, the elongated support member 24 includes a base portion 58 provided with two strengthening ribs 60 and 62 projecting upwardly perpendicular to the base portion 58 and extending longitudinally along the entire length thereof. The two ribs 60 and 62 are spaced laterally from each other in a direction perpendicular to the longitudinal axis of the lightbar 12. The elongated support member 24 also includes a pair of spaced facing mounting slots 64 for connecting the mounting foot assembly 14 to the lightbar 12 as described in the above mentioned U.S. Pat. No. 6,845,893. The elongated support member 24 further includes a pair of raised longitudinally extending planar surfaces 66, one extending along each of the outer edges of the elongated support member 24. The planar surfaces 66 are held in spaced relationship to the base portion 58 by spacing ribs 68. Each planar surface 66 is split longitudinally into two spaced sections and, together with the spacing ribs 68 and base portion 58, defines a longitudinally extending inverted T-shaped channel 69.

Each section 22a and 22b of the base 18 includes an end wall 70 as shown in FIGS. 3 and 7. When assembled, the sections 22a and 22b are positioned end to end with the end walls 70 adjacent to each other. A gasket 72 is positioned between the walls 70 of the two adjacent sections 22a and 22b to seal the inside of the lightbar assembly 12. It should be noted that the recess 26, including the channel 36 and the central segment 30 and outer segments 32, extends across the junction of the two sections 22a and 22b so the recess 26 is continuous between the two sections 22a and 22b. The elongated support member 24 is one piece and also extends across the junction of the two sections of the base 18.

As shown particularly in FIG. 2, when assembled, the elongated support member 24 is received within the recess 26 with the strengthening ribs 60 and 62 extending up into the channels 36 in the base 18 of the light bar. The base portion 58 of the elongated support member 24 between the ribs 60 and 62 is positioned against the bottom of the central segment 30 of the recess 26. The planar surfaces 66 of the elongated support member 24 are positioned against the bottom surface of the thermally conductive pads 54 positioned in the outer segment 32 of the recess 26. The downwardly extending projections 57 of the thermally conductive pads 54 extend into the longitudinally extending channels 69 in the elongated support member 24 when the elongated support member 24 is connected to the base 18 of the lightbar 12.

A plurality of longitudinal warning light modules 76 are mounted within the housing 16 of the lightbar 12 along the longitudinal axis. Although the warning light modules 76 may be of various types and combinations some light modules 76 may generally include a molded reflector 78 and LEDs 80 attached to a PC board 82. A lens (not shown) may be attached to the front of the reflector 78 to provide the desired radiation pattern.

The base or “slug” of each LED 80 is typically secured to the PC board 82 in a heat transmissive relationship. The PC board 82 is heat-conductive and may be a typical fiberboard provided with heat conductive copper pads and through-holes or may be a metal-core PC board as known in the art. The PC Board 82 is typically equipped with electrical leads for connecting the LEDs to each other and to the electrical circuit providing the energizing circuit.

Heatsinks, in the form of bracket members 86, function as thermal pathways and are attached to the PC boards 82 in heat transmitting relationship. The bracket members 86 are preferably fabricated from a heat conducting metal such as aluminum and include a base 88 and upstanding inner and outer flanges 90 and 92. The outer flanges 92 are positioned against and secured to the back surface of the PC boards 82 of the light modules 76 in heat transmitting relationship. The outer flanges 92 may be secured to their respective PC boards 82 by any suitable means such as screws or the like.

As shown in the embodiment of FIG. 7, there are six longitudinal warning light modules 76 mounted along the longitudinal axis in each of the sections 22a and 22b of the base 18. Three of the light modules 76 are positioned on the forward side of the ribs 34 and three on the rearward side. One bracket member 86 is associated with each set of three modules 76 on a side. In the case of the longitudinal light modules 76, each of the bracket members 86 includes a single outer flange 92 having its surface engaging and connected to the PC boards 82 of each of the three light modules 76 of it's associated set. The inner flange 90 of the bracket member 86 is positioned against the rib 34 in the base 18.

FIG. 7 shows one combination of light modules 94 that may be used at each of the ends of the lightbar assembly 12. As shown in FIG. 7 there are five identical end light modules 76 that are positioned around each inner end of the lightbar assembly 12. Each light module 94 includes a reflector, LEDs and a PC board. In the case of the end light modules 94, there is a single end bracket member 95 having a base 96 and five upstanding outer flanges 97, one for each of the light modules 94. An inner flange 98 of this bracket member 95 is positioned against a wall 100 extending upwardly from the bottom wall 28 of the base 18 of the housing 16. The wall 100 is located at the terminal ends of the ribs 34 in the base 18 as shown in FIG. 3. The base 96 of the end bracket member 95 includes a portion 102 at each end that extends around the wall 100 on the forward and rearward side thereof.

Although FIG. 7 shows five identical end light modules, other arrangements are possible. For example there may be a center halogen alley light and one light module with multiple LEDs positioned on either side thereof at an angle to the axis of the lightbar. Whatever the lighting arrangement, those modules with LEDs have their PC boards in heat transmissive engagement with a flange 97 of a bracket member 95. Also, although there are six longitudinal light modules 76 shown in the embodiment of FIG. 7, other lighting arrangements are possible. Whatever the arrangement, those light modules provided with LEDs would have their PC boards in thermal contact with a bracket 86.

As shown particularly in FIG. 8, the base 88 of each of the bracket members 86 is positioned against the inner surface 103 of the thermally conductive pads 54. The upwardly extending projections 56 of each of the thermally conductive pads 54 are received in mating apertures 104 in the base 88 of the bracket member 86. Each bracket members 86 includes a raised tab portion 106 extending from is outer end toward the end light modules 94. The raised tab portion 106 is configured to overlap the portion 102 of the bracket member 95.

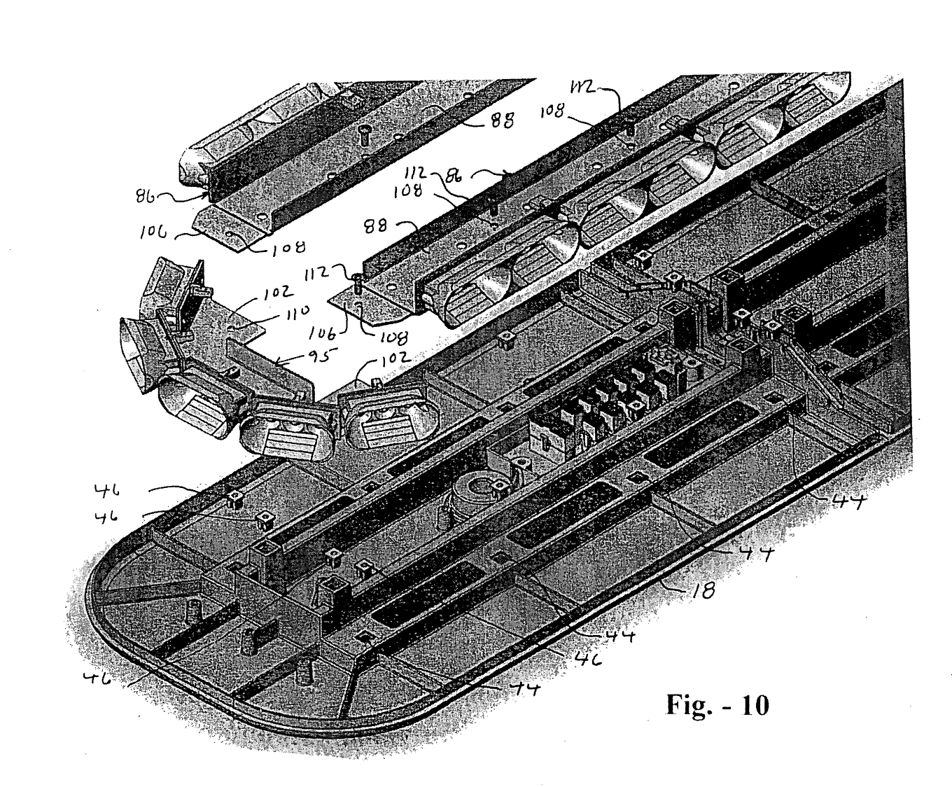

Referring to FIG. 9 and 10, the base 88 of each of the bracket members 86 is provided with holes 108 that align with the holes 44 in the base 18 of the housing 16 that have the screw grommets 46 positioned therein. The end bracket member 95 has holes 110 that are positioned in the portion 102 that underlies the tab portions 106 of the bracket members 95. The holes 108 in the tab portions 100 are coaxial with the holes 110 the portion 102 of the end light brackets 95 and with their respective holes 44 in the in the base 18 of the housing 16.

The expandable screw grommets 46 in the base 18 of the housing 16 extend through their respective holes 44 in the base 18 into the channel 69 in the elongated support member 24. Accordingly, when suitable screws 112 are passed through the holes 108 in the bracket members 86 into the screw grommets 46 and tightened to expand the screw grommet 46, the bracket members 86 are secured to the base 18 of the housing 16 as shown in FIG. 9. Additionally, the tightening of these screws 112 also serves to secure the elongated support member 24 within the recess 26 in the underside of the base 18. As the thermally conductive pads 54 have a thickness slightly greater than the thickness of the bottom wall 28 of the base 18 in which they are located, the base 88 of the longitudinal brackets 86 will lie flat against the inner surface 103 of the thermally conductive pads 54. The planar surfaces 66 of the support member 24 will lie flat against the outer surfaces 114 of the thermally conductive pads 54. By tightening the screws 112, the thermally conductive pads 54 are compressed between the base 88 of the bracket members 86 and the raised planar surfaces 66 the support member 24. This configuration provides a thermal pathway from the brackets 86 inside the housing 16, through the thermally conductive pads 54, to the support member 24 on the outside of the housing 16.

When all the components have been secured within the base 18 of the housing 16, the dome 20 may be secured to the base 18 of the housing by suitable screws 116 (FIG. 7) passing through the dome 20 into the screw grommets 46 in the raised posts 48 extending upwardly from the base 18.

With the above arrangement a heat transfer path is provided for dissipating the heat generated by the LEDs and preventing its accumulation within the housing. The thermally conductive pads 54 have their inner surfaces 103 exposed to the interior of the housing 16 and their outer surfaces 114 exposed to the exterior of the housing 16. The thermal pathway extends from the slug of the LEDs 80, through the PC boards 82, the bracket members 86 or 85 on the inside of the housing 16 and the thermally conductive pads 54 to the support member 24 on the outside of the housing 16. The above arrangement also permits the housing 16 to be fabricated from a material which is strong and relatively inexpensive while not particularly thermal transmissive such as an injection moldable thermoplastic like polycarbonate or the like. The thermally conductive pads 54, which require less material than the housing, are molded from a more expensive highly thermal transmissive material.

While preferred embodiments have been shown and described, various modifications and substitutions may be made thereto. Accordingly, it is understood that the present embodiments have been described by way of illustration and not limitation.

What is claimed is:

1. A lightbar assembly comprising:
a housing having a base;
at least one warning light module positioned within said housing and including at least one LED;
at least one thermally conductive pad mounted in said base;
a thermal pathway from each LED to said thermally conductive pad; and
a support member secured to the outside of the base of said housing, said support member being in contact with said thermally conductive pad.

2. The lightbar assembly of claim 1 wherein said LEDs are mounted on a heat conductive PC board, and said thermal pathway includes a heat conductive metallic element interposed between said PC board and said thermally conductive pad.

3. The lightbar assembly of claim 1 wherein said housing includes a dome connected to said base to form an enclosed space, and further including a plurality of warning light modules mounted in said enclosed space and a plurality of thermally conductive pads, at least some of said warning light modules including a reflector and an LED, said LEDs being attached to a heat-conductive PC board, said thermal pathway including a heat conductive metallic element interposed between said circuit board and said thermally conductive pads.

4. The lightbar assembly of claim 3 wherein each said thermally conductive pad has an inner surface exposed to the interior of said housing and an outer surface exposed to the outside of said housing, said heat conductive metallic element being in contact with said inner surface and said support member being in contact with said outer surface.

5. The lightbar assembly of claim 4 wherein said heat conductive metallic element includes at least one aluminum bracket member having a flange portion positioned against a PC board and a base portion positioned against the inner surface of said thermally conductive pads.

6. The lightbar assembly of claim 5 wherein said structural member is mounted in a recess in said base and includes longitudinally extending ribs projecting upwardly into channels in said base.

7. The lightbar assembly of claim 6 wherein said flange portion of each said bracket member is secured to its respective PC board and said base portion is secured to said base of said housing.

8. The lightbar assembly of claim 1 wherein said base includes openings for receiving said thermally conductive pads, and said thermally conductive pads are molded in place in said openings.

9. The lightbar assembly of claim 8 wherein said thermally conductive pads are a thermally conductive injection moldable thermoplastic material, and said housing is a plastic material which is less thermally conductive than the material of said pads.

10. The lightbar assembly of claim 8 wherein said base includes two separate molded sections positioned end to end, and said support member extends along the bottom of both sections, both section being secured to said extrusion member.

11. A light bar assembly comprising:
an elongated housing including a base;
a plurality of light modules mounted in said housing, at least some of said light modules including LEDs secured to a heat transmissive PC board;
thermally conductive plastic pads mounted in said base, each said pad having an inner surface exposed to the interior of said housing and an outer surface exposed to the exterior of said housing;
heat conductive metallic bracket members secured to said PC boards and having a surface in engagement with said inner surfaces of said thermally conductive pads; and
an elongated structural member secured to the underside of said base and in contact with the outer surface of said thermally conductive pads.

12. The lightbar assembly of claim 11 wherein said metallic bracket members include a base and at least one flange extending upwardly at right angles to said base, said flange being in contact with a respective PC board and said base being in contact with said inner surface of said thermally conductive pads.

13. The lightbar assembly of claim 11 wherein said structural member comprises an aluminum extrusion and said pads are a thermally conductive injection moldable thermoplastic material.

14. The lightbar assembly of claim 11 wherein said base has a bottom wall, and said thermally conductive plastic pads are positioned within said bottom wall, the thickness of said thermally conductive plastic pads being greater than the thickness of said bottom wall, whereby said thermally conductive plastic pads are compressed between a bracket and said structural member.

15. The lightbar assembly of claim 14 wherein said base includes openings for said thermally conductive plastic pads and said thermally conductive plastic pads are molded in place in said openings.

16. The lightbar assembly of claim 11 wherein said bracket has apertures therein and said thermally conductive plastic pads include at least one upstanding projection, said projections extending into said apertures.

17. The lightbar assembly of claim 16 wherein said structural member has at least one channel extending along the length thereof and said thermally conductive plastic pads have at least one downwardly extending projection, said downwardly extending projections extending into said channel.

18. The lightbar assembly of claim 11 wherein said structural member is mounted in a recess in said base and includes longitudinally extending ribs projecting upwardly into channels in said base of said housing.

19. The lightbar assembly of claim 11 wherein there are light modules positioned along the longitudinal length of the base and at the end thereof, said thermally conductive plastic pads being positioned along the longitudinal length of the base, longitudinal bracket members secured to said PC boards of said light modules positioned along the longitudinal length and having a surface in engagement with said thermally conductive pads, and end brackets secured to the PC boards of said end light modules bracket and having a surface engaging a longitudinal light bracket.

20. The lightbar assembly of claim 11 wherein said metallic bracket members include a base and a flange extending upwardly at right angles to said base, said flange being in contact with a respective PC board and said base being in contact with said inner surface of said thermally conductive plastic pads, said structural member comprises an aluminum extrusion, and said base has a bottom wall, said thermally conductive pads being positioned within said bottom wall, the thickness of said thermally conductive plastic pads being greater than the thickness of said bottom wall whereby said thermally conductive plastic pads are compressed between base of said bracket and said structural member.
